(19) United States
(12) Patent Application Publication
(10) Pub. No.: US 2008/0186532 A1
(43) Pub. Date: Aug. 7, 2008

(54) PRINT SYSTEM, PRINT PROGRAM, AND RECORDING MEDIUM

(76) Inventor: Naruhiko OGASAWARA, Chiba (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/961,192

(22) Filed: Dec. 20, 2007

(30) Foreign Application Priority Data
Feb. 5, 2007 (JP) 2007-024947

(51) Int. Cl. G06F 3/12

(52) U.S. Cl. 358/1.15

(57) ABSTRACT

A disclosed client-server type print system including a client device, a server device, and printers connected and configured to communicate via a network facilitates the installation of a printer driver in the server device. The server device creates a printer table of the printers on the network and sends it to the client device. A user selects one of the printers for printing a print job based on the printer table in the client device. The print job is sent to the server device together with information designating the selected printer. The server device acquires the information designating the selected printer and causes the selected printer to print the print job.

### BACKGROUND OF THE INVENTION

1. Field of the Invention

The present invention relates to print systems, print programs, and recording media. More particularly, it relates to a client-server type print system, print program, and recording medium.

2. Description of the Related Art

In the past several years, offices have been extremely networked using LANs (Local Area Networks), for example, via which client devices such as personal computers and word processing machines are connected to printers and the like, thereby enabling the sharing of files, printers, etc.

In a typical modern office environment, multiple printers are connected within a network, wherein a user can select a particular one of the printers depending on a particular requirement.

In such an environment, in order for a client device to utilize a printer, the client device needs to have installed a printer driver adapted to the printer. Generally, when multiple printers and client devices are connected directly via a network, each user installs a printer driver for an intended printer on his client device. The printer driver enables transmission of a print job to the designated printer via the network.

The past several years have also seen enhancements in printer functions, resulting in increases in the number of settings to be made by the users. As a result, it is now quite a chore just to select an appropriate printer and install a printer driver for it.

The present applicant has previously proposed a printer driver technology (see Japanese Laid-Open Patent Application No. 2005-182391) whereby customized information concerning computer performance and the like is read out into a customizing file by performing two-way communications between a computer and a printer. A printer driver is customized based on the customizing file and is then installed in the computer. In this way, the printer environment can be optimized for the user without requiring any special operations.

Thus, the above printer driver technology helps to reduce the burden on the user during the installation of a printer driver in the aforementioned environment, i.e., one in which a client device is connected to a printer directly (not just in a physical sense through a printer cable or the like, but also via a wired or wireless network connection), without going through a server device.

However, the aforementioned publication does not mention the case where client devices and printers are connected via a server device. Thus, a need has been felt for improving the aforementioned technology so that the installation of a printer driver in a client-server connection can be facilitated.

Specifically, in some cases, such as when it is necessary to limit an individual client device's access to a printer, a client-server type connection is used where client devices and printers are connected via a server device so that an administrator can manage connections comprehensively via the server device. In such a client-server type print system, the administrator needs to install a printer driver for each printer within the network on the server device, which puts an excessive burden on the administrator.

FIG. 12 shows an example of this type of print system comprising a client device 100, a server device 200, and printers 300A to 300Z, connected via a network. The printers 300A to 300Z are managed by the server device 200. When the client device 100 needs to print using one of the printers 300A to 300Z, such as the printer 300B, it first designates the printer 300B via the network. Then, in the case of a Windows (registered trademark of Microsoft Corp.) Operating System (OS), for example, one of the printer drivers 201A to 201Z corresponding to the designated printer 300B, i.e., the printer driver 201B, is automatically copied from the server device 200 onto the client device 100 by the so-called Point and Print technology. The copied printer driver 201B can then be used in the client device 100. This mechanism involves the Windows OS creating a print cue 202B, i.e., installing the printer driver 201B, and associating the print cue 202B with the designated printer 300B.

With the client device 100 thus connected to the print cue 202B via the network, a print job created by the printer driver 201B is passed through a module called a network print provider in the client device 100 and is eventually sent to the cue 202B in the server device 200. In this case, the print cue 202B, which is just a print cue from the viewpoint of the client device 100, is a local port to the server device 200 (i.e., an outlet in direct connection, not only in a physical sense but also including a network connection, with the server device 200 for supplying data to the printer 300B).

In this conventional client-server type print system, a system administrator needs to create all of the print cues 202A to 202Z for the corresponding printers 300A to 300Z that exist on the network. The burden on the system administrator involved could be excessive.

### SUMMARY OF THE INVENTION

It is a general object of the present invention to overcome the aforementioned problems of conventional art.

A more specific object of the invention is to provide a client-server type print system, print program, and recording medium whereby the burden on a system administrator during the installation of printer drivers on a server device can be reduced, and an enhanced user convenience can be achieved on the client device end in terms of printer selection.

In one aspect, the invention provides a print system comprising a client device and plural image forming devices connected to each other in a network via a server device. The server device comprises an image forming device managing unit configured to create an image forming device managing table for managing the image forming devices on the network; a job control unit configured to instruct the image forming device managing unit to create the image forming device managing table, transmit the created image forming device managing table to the client device, and receive a print job from the client device; and a job analysis unit configured to analyze the print job received by the job control unit and select one of the image forming devices for printing the print job. The client device comprises a print control unit configured to receive the image forming device managing table from the server device and enable the selection of one of the image forming devices based on the image forming device managing table. The print control unit is also configured to include information designating the selected image forming device in the print job and transmit the print job to the server device in response to a print request.

In a preferred embodiment, the image forming device managing unit is configured to create the image forming device managing table by retrieving information from the image forming devices on the network using a browsing function.

In another preferred embodiment, the image forming device managing unit is configured to edit or update the image forming device managing table that has been created.

In another preferred embodiment, the print control unit is configured to present a selection screen for selecting one of the image forming devices based on the image forming device managing table, and designate the selected image forming device as the image forming device for printing the print job.

In another preferred embodiment, the print control unit is configured to allow one of the image forming devices to be selected on an initial setting screen based on the image forming device managing table, and designate the selected image forming device as the image forming device for printing the print job in response to the print request.

In another preferred embodiment, in a case where one of the image forming devices has been selected on the initial setting screen in advance, the print control unit is configured to create and display a setting screen associated with the selected image forming device by performing a two-way communication with the selected image forming device.

In another preferred embodiment, in a case where none of the image forming devices is selected at the time of the print request, the print control unit is configured to present an image forming device selection screen based on the image forming device managing table, and designate one of the image forming devices that has been selected on the selection screen as the image forming device for printing the print job.

In another aspect, the invention provides a print program for causing a computer to carry out a method of printing a print job in a print system in which a client device and plural image forming devices are connected via a server device on a network. The method comprises the steps of: creating an image forming device managing table in the server device for managing the plural image forming devices on the network; transmitting the image forming device managing table from the server device to the client device; selecting one of the plural image forming devices in the client device based on the image forming device managing table that has been received; transmitting a print job including information designating the selected image forming device from the client device to the server device; receiving the print job in the server device; determining the selected image forming device by analyzing the received print job; and printing the print job using the selected image forming device.

In another aspect, the invention provides a recording medium in which the above print program is recorded.

In accordance with the present invention, a server device is configured to create an image forming device managing table that lists image forming devices on a network and send it to a client device. The client device can then select one of the image forming devices for printing of a print job based on the image forming device managing table. Once the image forming device is selected, the client device attaches information indicating the selected image forming device to a print job and sends the print job to the server device. The server device then acquires the information about the selected image forming device based on the print job and causes the selected image forming device to print the print job. In this way, the burden on a system administrator during the installation of a printer driver for each of the image forming devices on the server device can be reduced. At the same time, enhanced convenience in terms of selection of a printer by a user on the client device end can be achieved.

These and other objects, advantages and features of the invention are described in conjunction with the accompanying drawings.

### BRIEF DESCRIPTION OF THE DRAWINGS

FIG. 1 shows a system configuration of a print system according to an embodiment of the invention;

FIG. 2 shows a software configuration of a client device and a server device in the print system shown in FIG. 1;

FIG. 3 shows an example of a printer table in the embodiment of FIG. 1;

FIG. 4 shows a sequence chart of a process of installing a printer driver in the server device of FIG. 2;

FIG. 5 shows a sequence chart of a process of installing a printer driver in the client device of FIG. 2;

FIG. 6 shows a sequence chart of a process of updating a printer table in the server device of FIG. 2;

FIG. 7 shows an example of a printer table setting screen displayed on the server device during the printer table updating process of FIG. 6;

FIG. 8 shows a sequence chart of a process of printing a print job in response to a print operation performed on the client device of FIG. 2;

FIG. 9 shows an example of a printer selection screen displayed on the client device during the print process of FIG. 8;

FIG. 10 shows an example of printer information embedded in print data during the print process of FIG. 8;

FIG. 11 illustrates a process of creating a printer driver cue and a print process performed by the print system of FIG. 1; and

FIG. 12 illustrates a process of creating a printer driver cue and a print process performed by a conventional print system.

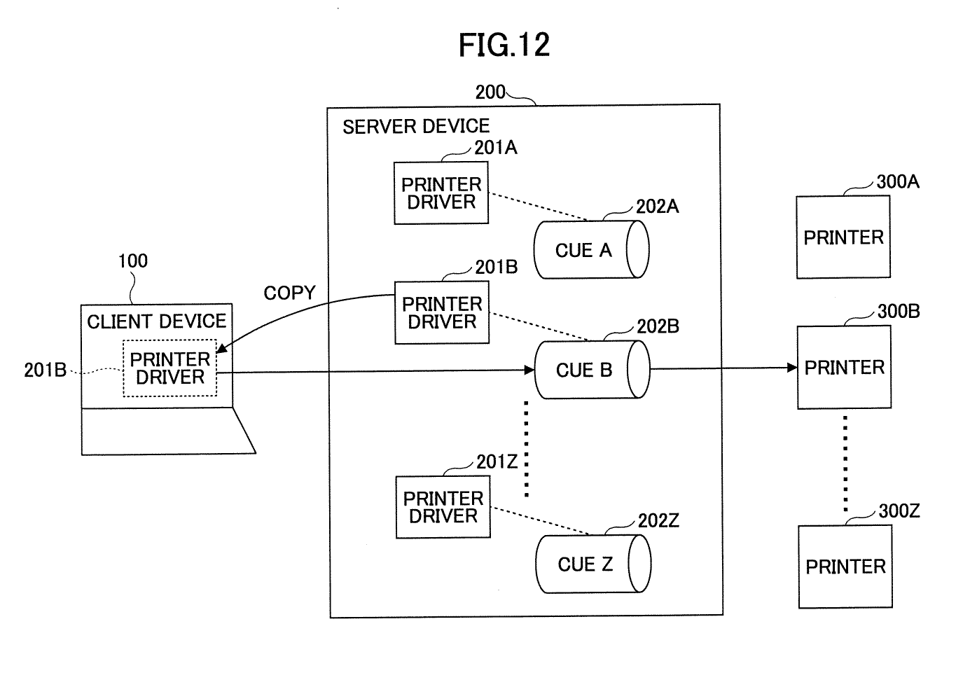

### DETAILED DESCRIPTION OF THE PREFERRED EMBODIMENTS

In the following, the present invention is described by way of a preferred embodiment with reference to the attached drawings. The description in the following is that of a preferred embodiment of the present invention with various, technically preferred limitations; the scope of the present invention, however, is not limited to such embodiment.

### Embodiment 1

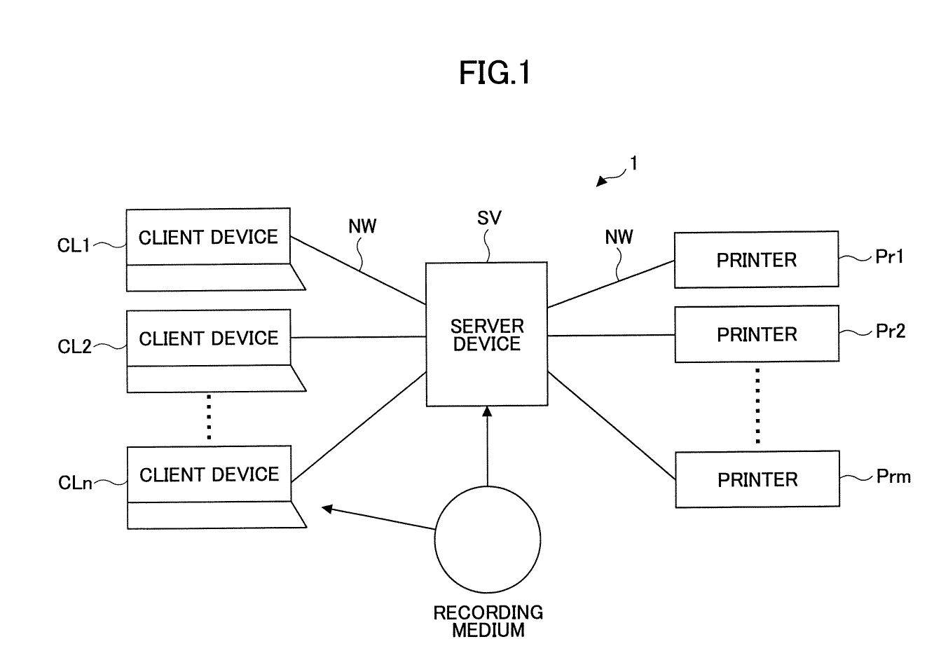

FIG. 1 shows a print system 1 of a client-server type according to an embodiment of the invention. The print system 1 comprises plural client devices CL1 to CLn that are connected to a server device SV, which is connected to plural printers (image forming devices) Pr1 to Prm, via a network NW. A print program and necessary data are read from a recording medium, such as a CD-R, and saved on a hard disc or the like of the server device SV and the client devices CL1 to CLn.

The printers Pr1 to Prm may comprise printers of various types, such as an electrophotographic type and an ink-jet type. The printers Pr1 to Prm are configured to analyze a print job sent from the server device SV and output print data on a sheet in accordance with the print settings of the print job. The printers Pr1 to Prm are merely an example; other types of image forming device can be used as long as they are capable of network connection and printing a print job sent from the client devices CL1 to CLn. Examples include copiers, facsimiles, and multifunctional peripherals.

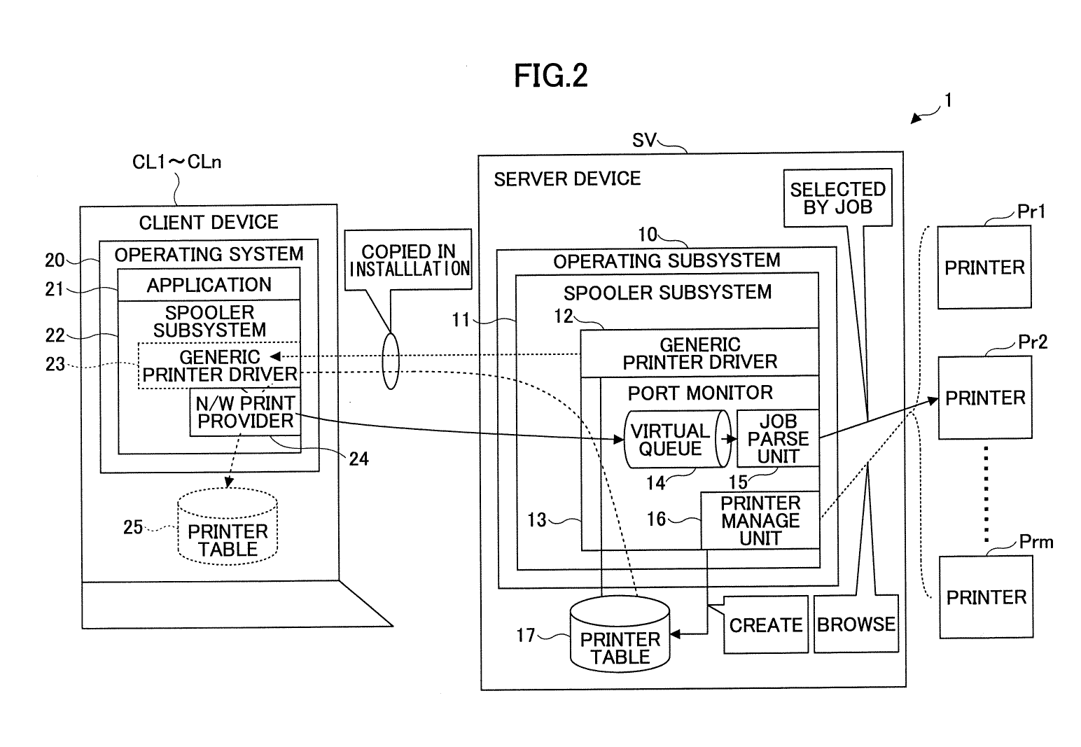

The server device SV comprises a normal computer with its hardware, for example. Its software, including an OS (Operating System) 10, is configured as shown in FIG. 2. Specifically, the server device SV comprises a spooler subsystem 11; a generic printer driver 12; a port monitor 13; a virtual cue 14; a job parse unit 15; and a printer manage unit 16. These units or components are implemented on the OS 10. A printer table 17 is also saved in the computer's hard disc, for example.

In accordance with the present embodiment, the OS 10 is a Windows. However, this is merely an example and other types of OS may be used.

The spooler subsystem 11 is a software module configured to manage the print functionality of the OS 10 as it relates to the printer driver 12 and the port monitor 13, for example.

The server device SV reads a print program and other necessary data stored in a recording medium, and save them in the hard disc, for example, so as to provide the spooler subsystem 11 and perform a print managing process as described later. Examples of the recording medium include a CD (Compact Disc); an MO (magneto-optical disc); a CD-ROM (Compact Disc Read Only Memory); a CD-RW (Compact Disc Rewritable); a DVD (Digital Video Disk); a memory card; and a flexible disc.

The printer driver 12 is configured to generate print data in a PDL (Page Description Language) in accordance with print instructing information received from the client devices CL1 to CLn. The printer driver 12 then attaches printer information included in the print instructing information to the print data, and then delivers the data to the port monitor 13.

The port monitor 13 is a functional unit that performs communications with the printers Pr1 to Prm. The port monitor 13 includes the virtual cue 14, the job parse unit 15, and the printer manage unit 16. The port monitor 13 sends to the job parse unit 15 a request to analyze the print data received from the printer driver 12, and transmits the print job to one or more of the printers Pr1 to Prm in accordance with the result of analysis by the job parse unit 15.

The virtual cue 14 processes the reception of data from the client devices CL1 to CLn in a manner as if the client devices CL1 to CLn were connected to the printers Pr1 to Prm. The port monitor 13, which includes the virtual cue 14, functions as a job control unit.

The job parse unit (job analysis unit) 15 is configured to analyze print data in response to an analysis request from the port monitor 13, select one of the printers Pr1 to Prm for printing the print job, and delivers an analysis result to the port monitor 13.

The printer manage unit (image forming device managing unit) 16 resides within the port monitor 13. It creates (“Create” in FIG. 2), manages, updates, and refers to a printer table (image forming device managing table) 17 in accordance with a request from the port monitor 13.

More specifically, the printer manage unit 16 is configured to create the printer table 17 for managing the printers Pr1 to Prm under its control, in association with the printer driver 12. Upon installation of the printer driver 12 in any of the client devices CL1 to CLn by the Point and Print technology of Windows, the printer table 17 that is under the control of the driver is also copied onto the particular client device.

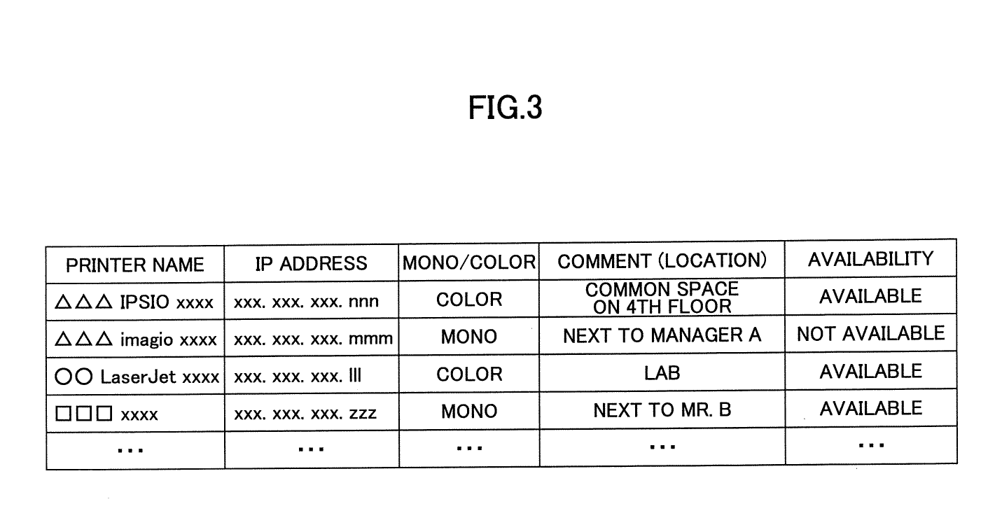

The printer table 17, which is created by the printer manage unit 16 and saved in the hard disc or the like (not shown) as mentioned above, is composed of information concerning printer name, IP address of the printers Pr1 to Prm on the network NW, whether monochrome or color, comment (location), and availability, as shown in FIG. 3. The information other than availability stored in the printer table 17 can be acquired using a browsing function via the network NW and a network managing protocol, such as the SNMP (Simple Network Management Protocol). Such information is acquired by the printer manage unit 16 and set in the printer table 17. The availability information is acquired by the printer manage unit 16 based on an availability setting made by the system administrator and then incorporated into the printer table 17.

The client devices CL1 to CLn each comprise a personal computer with its normal hardware, for example. Their software configuration is set up as shown in FIG. 2. Specifically, each of the client devices CL1 to CLn comprises an application 21; a spooler subsystem 22; a generic printer driver 23; and a N/W print provider 24, for example, which are implemented on an OS 20. A printer table 25 is stored in a hard disc or the like.

In the present embodiment, the client devices CL1 to CLn mount a Windows as the OS 20, as in the server device SV. This is, however, merely an example and the OS 20 may be provided by a non-Windows OS.

The application 21 includes document creation software, graphics creation software, spreadsheet software, and database software, for example. Created or edited document data is printed upon instruction by the user.

The spooler subsystem 22 is a software module for managing the print functions of the OS. Specifically, it manages the printer driver 23 and the N/W print provider 24.

The client devices CL1 to CLn are configured to read a print program and necessary data recorded in a recording medium, such as a CD mentioned above, and save them on the hard disc or the like as the spooler subsystem 22, so as to perform a print management process as described below.

During the initial setting of the client device CL1 to CLn, upon designation of one of the printers Pr1 to Prm by a user, the spooler subsystem 22 instructs the server device SV to create a printer icon by the Point and Print technology of the Windows OS 20.

In response to the printer icon creation instruction from the client device CL1 to CLn, the printer driver 12 copies itself onto the client device as the printer driver 23. Since, as mentioned above, the printer driver 12 in the server device SV has the printer table 17 under its control, the printer table 17 is also copied onto the client device upon copying of the printer driver 12. The thus copied printer table 17 is stored as the printer table 25 in the hard disc or the like of the client device CL1 to CLn.

Thus, the printer driver (print control unit) 23 is copied from the server device SV and installed in the client device by the Point and Print technology of the Windows OS. In response to a print instruction from the user via the application 21, the printer driver 23 refers to the printer table 25, causes a printer selection screen to be displayed on a display, and prompts the user to select one of the printers Pr1 to Prm for printing a print job. Upon selection of one of the printers by the user, the printer driver 23 generates print instruction information to which information designating the selected printer for the print job is attached in PJL (Printer Job Language) format. The print instruction information is then delivered to the N/W print provider 24.

The N/W print provider 24 transmits the print instruction information received from the printer driver 23 to the virtual cue 14 in the server device SV via the network NW.

The operation of the present embodiment is described below. In accordance with the print system 1 of the present embodiment, the burden on the system administrator during the installation of the printer driver 12 on the server device SV can be reduced, while enhanced convenience can be achieved on the side of the client devices CL1 to CLn in terms of user selection from the printers Pr1 to Prm.

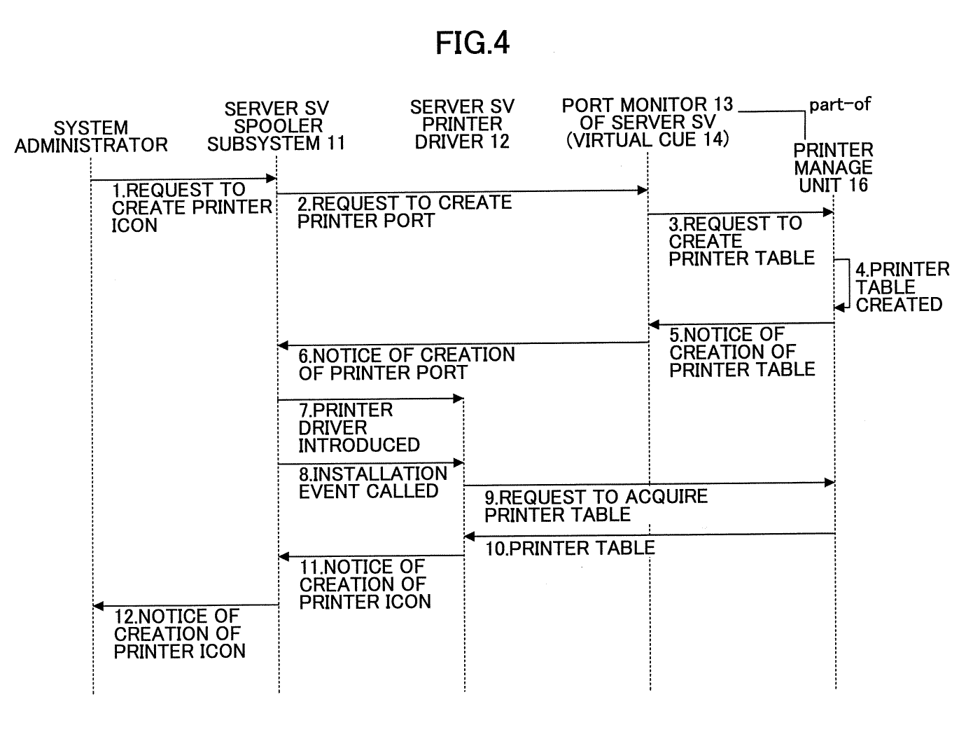

Initially, a process of installing the printer driver 12 on the server device SV is described with reference to FIG. 4, in which the numbers “1” to “12” indicate the order of process steps.

As the system administrator performs a printer icon (cue) creation operation, the spooler subsystem 11 in the server device SV sends a printer port creation request to the port monitor 13. This is because the creation of a printer icon requires, initially, the creation of a port.

The port monitor 13, in response to the printer port creation request from the spooler subsystem 11, sends a printer table creation request to the printer manage unit 16. The printer manage unit 16, in accordance with the request, creates the printer table 17 of the printers Pr1 to Prm connected to the network NW. Upon completion of the creation of the printer table 17, the printer manage unit 16 sends a printer table creation completion notice to the port monitor 13. For the creation of the printer table 17, the printer manage unit 16 employs a method whereby, for example, broadcast is performed within the same segment based on TCP/IP (Transmission Control Protocol/Internet Protocol) to retrieve and list the printers Pr1 to Prm. Alternatively, it may employ Bonjour (technology allowing proper management of the addresses and names of devices on a network based on TCP/IP, and automatic discovery of services provided on the network) or other browsing functions such as UPnP (Universal Plug and Play), which searches for devices on a network and connect them, and WSD (Web Services for Devices). Using such technology, the printer manage unit 16 retrieves information from the printers Pr1 to Prm on the network NW and creates the printer table 17 as shown in FIG. 3, for example.

The port monitor 13, in response to the printer table creation completion notice from the printer manage unit 16, creates a printer port associated with the virtual cue 14. The port monitor 13 then sends a printer port creation completion notice to the spooler subsystem 11.

The spooler subsystem 11, upon reception of the printer port creation completion notice, introduces the printer driver 12. Upon installation of the printer driver 12, the spooler subsystem 11 calls an event from the printer driver 12 that is run upon installation.

The event involves the printer driver 12 sending a request to the printer manage unit 16 in the port monitor 13 for the acquisition of the printer table 17. The printer manage unit 16, in response to the printer table acquisition request, delivers the printer table 17 to the printer driver 12. Thereafter, the printer table 17 is placed under the control of the printer driver 12. Thus, the port monitor 13 performs the process of installing the printer driver 12 and associating it with the printers Pr1 to Prm, i.e., the creation of the virtual cue 14.

The printer driver 12 notifies the spooler subsystem 11 of the completion of creation of the printer icon. The spooler subsystem 11 then notifies, via a user interface UI, the system administrator of the creation of the printer icon.

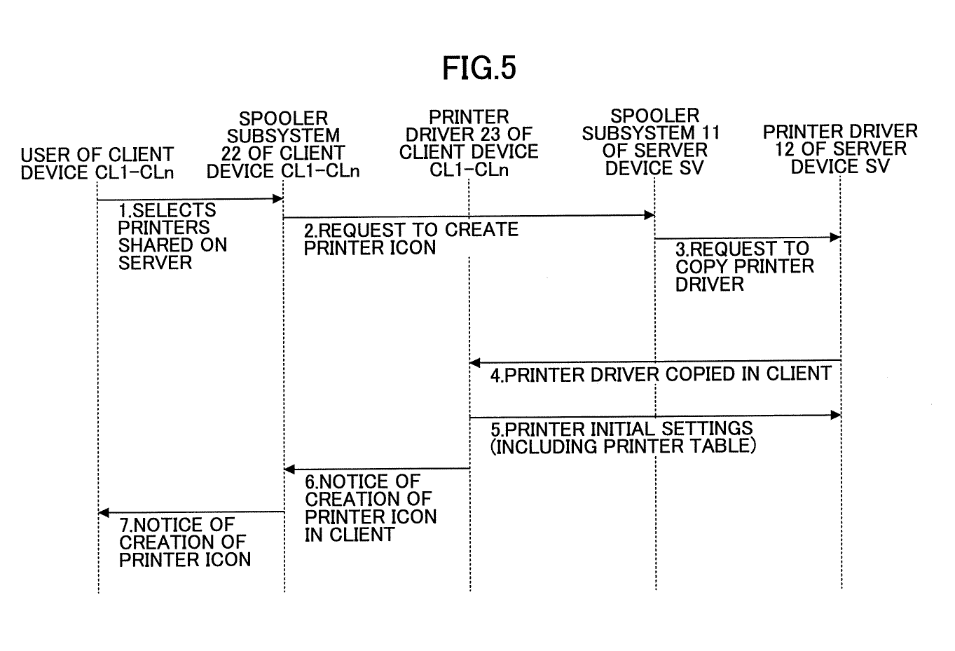

With the printer driver 12 thus installed in the server device SV, the client devices CL1 to CLn connected to the network NW are initialized as shown in FIG. 5. In this initial setting process, the printer driver 12 is copied onto the client devices CL1 to CLn by the Point and Print technology of Windows OS, together with initial setting information including the printer table 17. The numbers “1” to “7” in FIG. 5 indicate the order of process steps.

Referring to FIG. 5, as a user operates one of the client devices CL1 to CLn and designates the printers Pr1 to Prm on the side of the server device SV, the spooler subsystem 22 of the client device CL1 to CLn sends a printer icon creation instruction request to the spooler subsystem 11 in the server device SV. The spooler subsystem 11 in the server device SV then sends a printer driver copy request to the printer driver 12 corresponding to the designated printers Pr1 to Prm to copy itself onto the client device CL1 to CLn.

The printer driver 12 of the server device SV copies itself onto the client device CL1 to CLn in the form of the printer driver 23 while at the same time it copies the initial setting information about the printers. The initial setting information that is copied by the printer driver 12 onto the client device CL1 to CLn includes the printer table 17. Namely, since the printer table 17 is placed under the control of the printer driver 12, it is also copied onto the client device CL1 to CLn as part of the initial setting information upon copying of the printer driver 12.

The copied printer driver 23 in the client device CL1 to CLn notifies its spooler subsystem 22 of completion of the entire operation. The spooler subsystem 22 then notifies, via the user interface (UI), the user of the client device CL1 to CLn that the selected printers are now available.

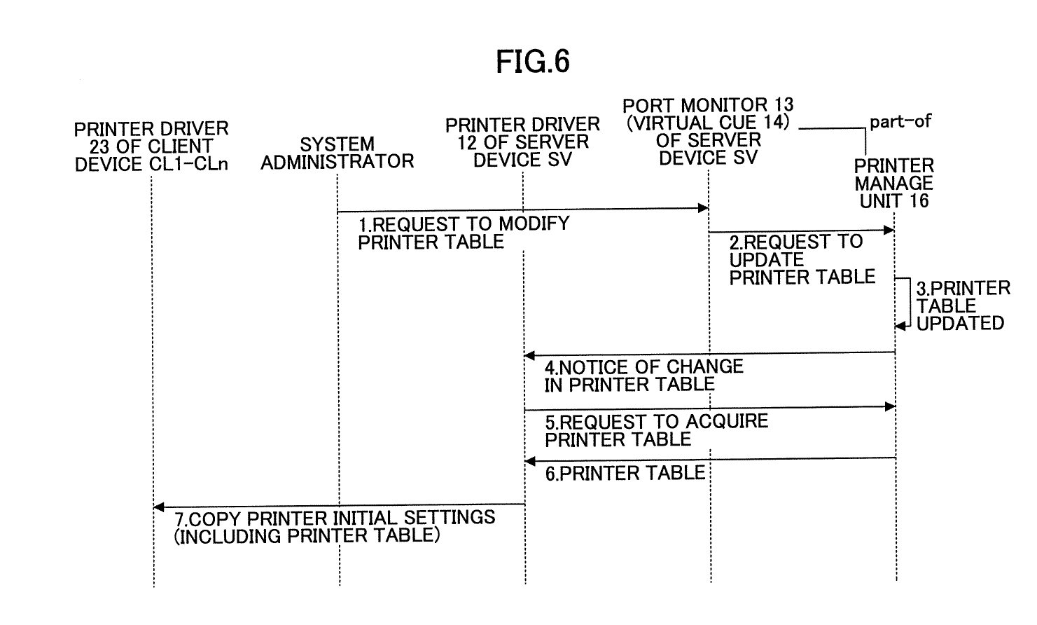

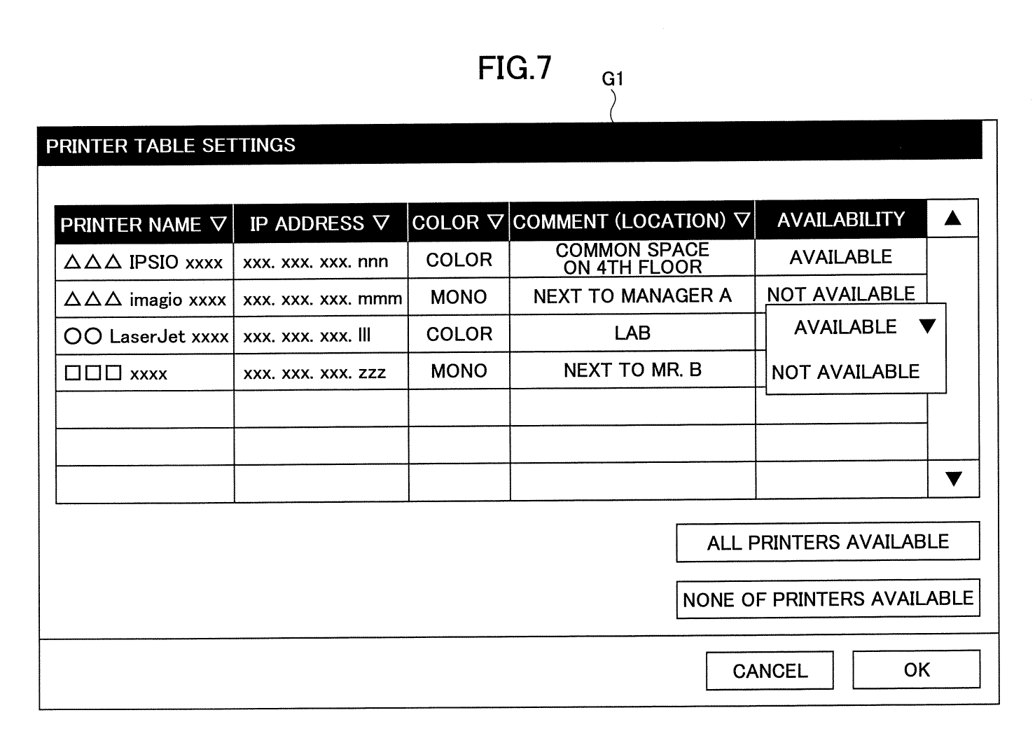

After the printer table 17 is thus copied onto the client device CL1 to CLn as described above as part of the initial setting information, together with the printer driver 23, the system administrator can then update the printer table 17 as needed, as is described below with reference to FIGS. 6 and 7. The numbers “1” to “7” in FIG. 6 indicate the order of process steps. It is noted here that while the spooler service normally exists in both the client devices CL1 to CLn and the server device SV, description of such service is omitted as it is irrelevant to the subject of the present invention.

Referring to FIG. 6, when updating the printer table 17, the system administrator first operates the server device SV and sends a request to the port monitor 13 of the server device SV to update the printer table 17.

The content of the printer table 17 can be edited by a variety of methods. For example, a method may be employed whereby the port monitor 13 causes an initial setting screen G1 to be displayed on a display as shown in FIG. 7. The initial setting screen G1 provides by itself a user interface (UI) allowing the editing of the printer table 17. In another exemplary method, the file format of the printer table 17 (such as in CSV or XML) may be published, so that the printer table 17 can be updated by an instruction to re-read a printer table 17 modified with an arbitrary editor or the like.

With reference to FIG. 7, information other than “Availability” is, as mentioned above, acquired and set by the printer manage unit 16 using a browsing function via the network NW and a network management protocol (such as SNMP). Thus, the information concerning “Availability” alone can be updated by the system administrator by operating on the screen and having the printer manage unit 16 acquire an edited content.

In response to the printer table update request, the port monitor 13 of the server device SV sends a request to the printer manage unit 16 to update the printer table 17. The printer manage unit 16, based on the update information delivered from the port monitor 13 concerning the printer table 17, updates the printer table 17.

The printer manage unit 16, after having updated the printer table 17, notifies the printer driver 12 of the modification of the printer table 17 that has been made. In response, the printer driver 12 sends a request to the printer manage unit 16 to acquire the printer table 17.

The printer manage unit 16, in response to the printer table acquisition request from the printer driver 12, acquires the printer table 17 and sends it back to the printer driver 12.

The printer driver 12, after having acquired the updated printer table 17, incorporates the printer table 17 into the printer initial setting information under its control, thereby updating the printer initial setting information and completing the updating process concerning the printer table 17.

When the OS 10 is a Windows, any modification of the printer initial setting information is automatically transmitted to the client devices CL1 to CLn by a Windows OS functionality. Thus, when the modification of the initial setting information about any of the printers Pr1 to Prm is transmitted, the printer table 17 is also transmitted as one item of the initial setting information. As a result, the printer driver 23 on the side of the client devices CL1 to CLn can handle the updated printer table 17.

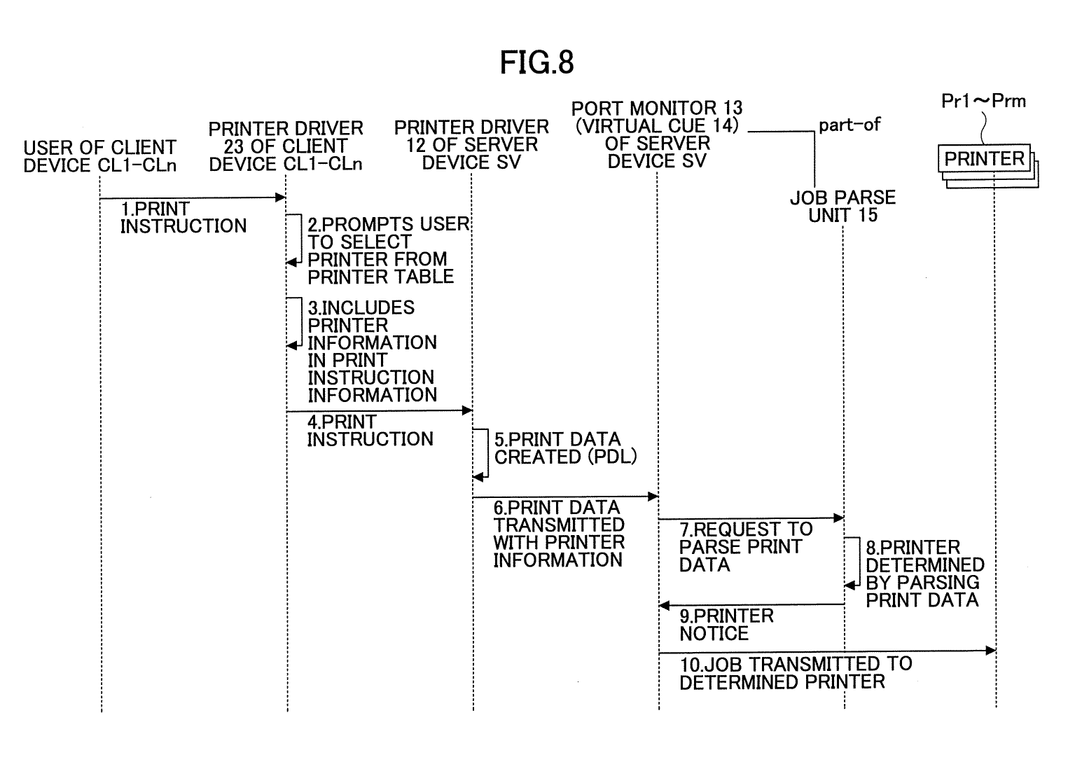

In the following, a print process in response to a print request from the client device CL1 to CLn is described with reference to FIGS. 8 to 10. In FIG. 8, the numbers “1” to “10” indicate the order of process steps. This print process inherently involves a process associated with the application 21 on the side of the client devices CL1 to CLn and services associated with the spooler subsystem 11 in both the client devices CL1 to CLn and the server device SV; however, such process and services are irrelevant to the subject of the present invention and their description with reference to FIG. 8 is omitted for simplicity's sake.

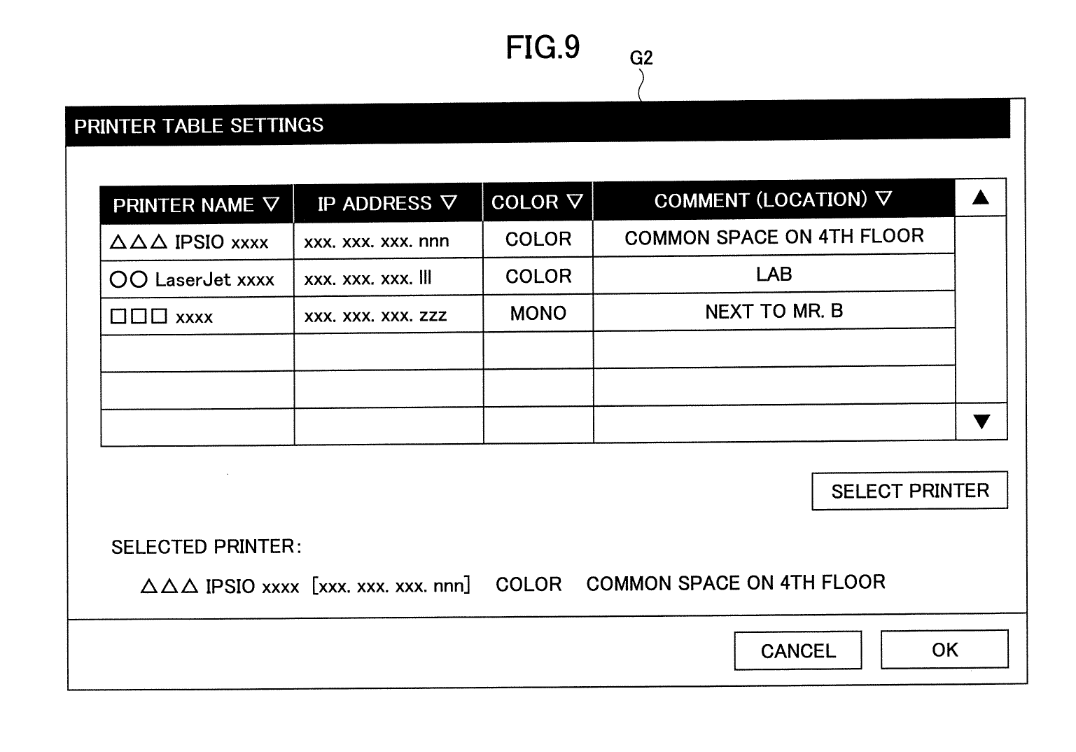

Referring to FIG. 8, as a user of one of the client devices CL1 to CLn operates the application 21 and sends a document print instruction to the printer driver 23, the printer driver 23, referring to the printer table 17 that it manages as part of the printer initial setting information, causes a printer selection screen G2 as shown in FIG. 9, for example, to be displayed on a display, and prompts the user to select one of the printers Pr1 to Prm to be used for the print job.

The selection from the printers Pr1 to Prm may be made by a different method. For example, one of the printers Pr1 to Prm may be selected from the printer table 17 in advance by the user on a conventional printer initial setting screen, prior to performing the print instructing operation.

In this case, since one of the printers is designated prior to the print instructing operation, a printer initial setting screen adapted to the designated printer can be displayed as long as the printer driver 23 is capable of creating an appropriate printer initial setting screen by performing a two-way communication with the selected printer.

If the user has not designated one of the printers Pr1 to Prm in advance in this arrangement, the printer selection screen G2 of FIG. 9 may be displayed to prompt the user to select one of the printers Pr1 to Prm.

The printer driver 23 then attaches information indicating the selected printer to the print instruction information in PJL format and sends the print instruction information to the printer driver 12 of the server device SV via the spooler service, so as to cause the printer driver 12 to perform rendering (into PDL, i.e., a process of generating command strings for controlling the printer).

Alternatively, in the case of a Windows OS, rendering may be performed by the printer driver 23 in the client device CL1 to CLn.

The printer driver 12 on the side of the server device SV, in response to the print instruction from the client device CL1 to CLn, generates print data (PDL) based on the print instruction information. The printer driver 12 then includes the printer-designating information attached to the print instruction information in the generated print data (print data) and delivers it to the port monitor 13.

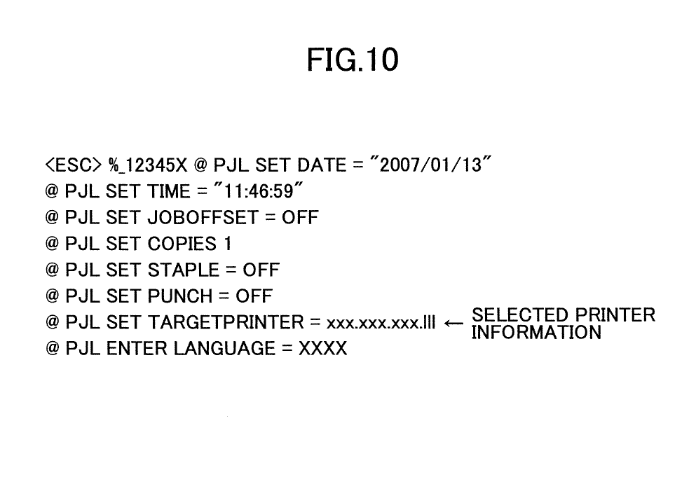

Specifically, the printer-designating information is embedded in the print data as shown in FIG. 10, for example, where control commands are in PJL format. As shown, the designated printer, indicated by “Selected printer information,” is embedded within the print data in terms of a relevant IP address associated with a variable “TARGETPRINTER.” While in the case of FIG. 10 the designated printer information consists of an IP address, this is merely an example; any other type of information may be used as long as it can be associated with actual printers Pr1 to Prm on a one-to-one basis.

Upon reception of the print data and the printer-designating information, the port monitor 13 sends a print data analysis request to the job parse unit 15, which is a part of the port monitor 13. The job parse unit 15 then analyzes the print data and determines the designated printer.

The job parse unit 15 then notifies the port monitor 13 as to which is the designated printer, whereby the port monitor 13 can know to which one of the printers Pr1 to Prm data is to be sent.

The port monitor 13 transmits the print job to the printer indicated by the job parse unit 15, using a known protocol (such as lpr or PORT 9100). The printer Pr1 to Prm that has received the print job prints the print job.

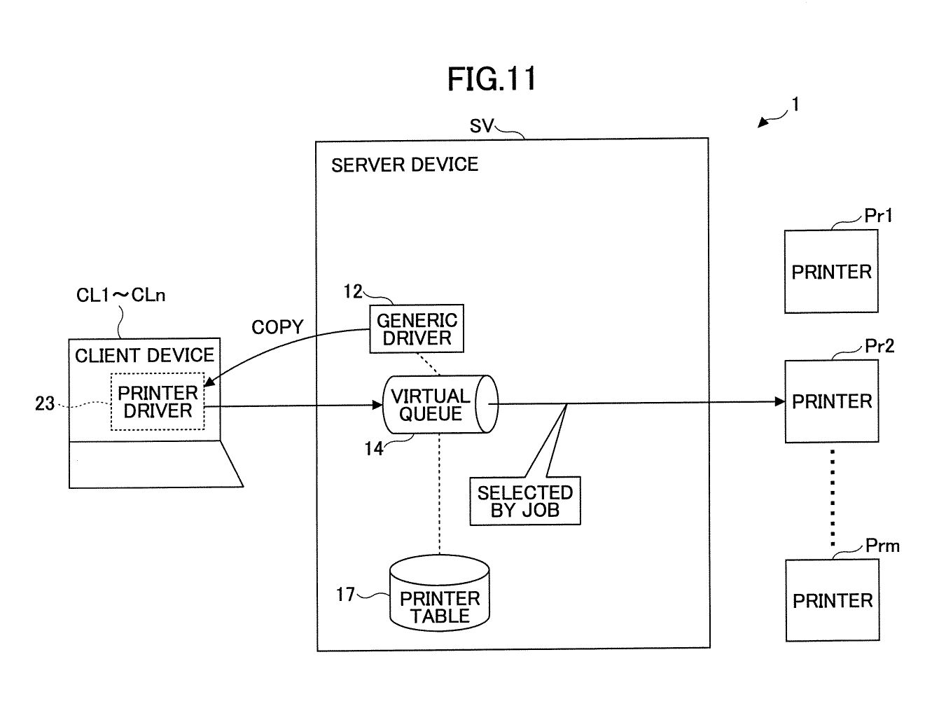

Thus, in accordance with the print system 1 of the present embodiment, the virtual cue 14 for comprehensively handling all of the printers Pr1 to Prm that exist on the network NW is created on the side of the server device SV, as shown in FIG. 11. As a result, the printer cue needs to be created only once in the printer driver 12. Furthermore, since the virtual cue 14 in the server device SV creates the printer table 17 listing the printers Pr1 to Prm under its control and sends it to the client device CL1 to CLn, the burden on the system administrator can be reduced while also enabling a user on the side of the client devices CL1 to CLn to readily and appropriately select one of the printers Pr1 to Prm for an actual printing operation.

More specifically, in accordance with the print system 1 of the present embodiment, the server device SV is configured to create the printer table 17 of the printers Pr1 to Prm on the network NW, save it, and send it to the client device CL1 to CLn. The client device CL1 to CLn then saves the printer table 17 in the form of the printer table 25, so that the user can select one of the printers Pr1 to Prm based on the printer table 25 for printing a print job. Upon selection of one of the printers Pr1 to Prm, a print job designating the selected printer is sent to the server device SV. The server device SV then determines the designated printer from the print job and causes the designated printer to print the print job.

In this way, the burden on the system administrator during the installation of the printer driver 12 for the respective printers Pr1 to Prm on the server device SV can be reduced, while enhanced convenience can be achieved on the side of the client devices CL1 to CLn in terms of selection of a printer by the user.

In accordance with the print system 1 of the present embodiment, the printer manage unit 16 is configured to retrieve information from the printers Pr1 to Prm on the network NW using a browsing function, so as to create the printer table 17.

Thus, the printer table 17 can be created readily and appropriately, whereby the burden on the system administrator during the installation of the printer driver 12 on the server device SV can be effectively reduced while achieving enhanced convenience on the side of the client devices CL1 to CLn in terms of selection of a printer by a user.

Furthermore, in accordance with the print system 1 of the present embodiment, the printer table 17 that has been created can be edited and updated using the printer manage unit 16.

Thus, the system administrator can edit or update the printer table 17 as needed for reasons associated with the management of the printers Pr1 to Prm, whereby the printers Pr1 to Prm can be managed more appropriately.

Furthermore, in accordance with the print system 1 of the present embodiment, the printer driver 23 on the side of the client devices CL1 to CLn is configured to present the printer selection screen G2 based on the printer table 25 received from the server device SV, wherein one of the printers Pr1 to Prm is selected on the printer selection screen G2 as the printer to be used for printing a print job.

Thus, a user of the client device CL1 to CLn can readily and appropriately select a printer on the printer selection screen G2, whereby enhanced convenience can be achieved.

Furthermore, in accordance with the print system 1 of the present embodiment, one of the printers Pr1 to Prm can be selected from the printer table 17 as mentioned above on the printer initial setting screen, wherein the printer driver 23 on the side of the client device CL1 to CLn designates the thus selected printer upon sending a print request.

In this way, a user of the client device CL1 to CLn can select one of the printers for printing a print job on the printer initial setting screen easily and appropriately, whereby enhanced usability can be achieved.

In a case where one of the printers Pr1 to Prm is selected in advance on the initial setting screen, the printer driver 23 may create and display a setting screen corresponding to the selected printer by performing a two-way communication with the selected printer.

In this way, print settings for the selected printer can be made easily and appropriately, whereby enhanced usability can be achieved.

In this case, if none of the printers Pr1 to Prm has been selected for printing a print job at the time of a print request, the printer driver 23 of the client device CL1 to CLn may present the printer selection screen G2 based on the printer table 25, as described above, so that one of the printers Pr1 to Prm can be selected on the printer selection screen G2 for printing a print job.

In this way, one of the printers Pr1 to Prm can be reliably and easily selected for printing a print job, whereby enhanced usability can be achieved.

While the present invention has been described with reference to a preferred embodiment, the invention is not limited by the embodiment. Various changes and modifications may occur to one skilled in the art without departing from the scope of the invention defined by the appended claims.

The present invention can be applied to a print system of a client-server type in which a printer cue is created in a server device to enable the use of one or more of printers connected to a network.

The present application is based on the Japanese Priority Application No. 2007-024947 filed Feb. 5, 2007, the entire contents of which are hereby incorporated by reference.

What is claimed is:

1. A print system comprising a client device and plural image forming devices connected to each other in a network via a server device;
wherein the server device comprises
an image forming device managing unit configured to create an image forming device managing table for managing the image forming devices on the network;
a job control unit configured to instruct the image forming device managing unit to create the image forming device managing table, transmit the created image forming device managing table to the client device, and receive a print job from the client device; and
a job analysis unit configured to analyze the print job received by the job control unit to determine which one of the image forming devices has been selected for printing the print job;
wherein the client device comprises a print control unit configured to receive the image forming device managing table from the server device and enable the selection of at least one of the image forming devices based on the image forming device managing table, the print control unit also being configured to include information designating the at least one selected image forming device in the print job and transmitting the print job to the server device in response to a print request.

2. The print system according to claim 1, wherein the image forming device managing unit is configured to create the image forming device managing table by retrieving information from the image forming devices on the network using a browsing function.

3. The print system according to claim 1, wherein the image forming device managing unit is configured to edit or update the image forming device managing table that has been created.

4. The print system according to claim 1, wherein the print control unit is configured to present a selection screen for selecting at least one of the image forming devices based on the image forming device managing table, and designate the at least one selected image forming device as the image forming device for printing the print job.

5. The print system according to claim 1, wherein the print control unit is configured to allow at least one of the image forming devices to be selected on an initial setting screen based on the image forming device managing table, and designate the at least one selected image forming device as the image forming device for printing the print job in response to the print request.

6. The print system according to claim 5, wherein, in a case where at least one of the image forming devices has been selected on the initial setting screen in advance, the print control unit is configured to create and display a setting screen associated with the at least one selected image forming device by performing a two-way communication with the at least one selected image forming device.

7. The print system according to claim 5, wherein, in a case where none of the image forming devices is selected at the time of the print request, the print control unit is configured to present an image forming device selection screen based on the image forming device managing table, and designate at least one of the image forming devices that has been selected on the selection screen as the image forming device for printing the print job.

8. A computer-readable print program for causing a computer to carry out a method of printing a print job in a print system in which a client device and plural image forming devices are connected via a server device on a network, the method comprising the steps of:
creating an image forming device managing table in the server device for managing the plural image forming devices on the network;
transmitting the image forming device managing table from the server device to the client device;
selecting at least one of the plural image forming devices in the client device based on the image forming device managing table that has been received;
transmitting a print job including information designating the at least one selected image forming device from the client device to the server device;
receiving the print job in the server device;
determining the at least one selected image forming device by analyzing the received print job; and
printing the print job using the at least one selected image forming device.

9. A computer-readable recording medium storing a print program for causing a computer to carry out a method of printing a print job in a print system in which a client device and plural image forming devices are connected via a server device on a network, the method comprising the steps of:
creating an image forming device managing table in the server device for managing the plural image forming devices on the network;
transmitting the image forming device managing table from the server device to the client device;
selecting at least one of the plural image forming devices in the client device based on the image forming device managing table that has been received;
transmitting a print job including information designating the at least one selected image forming device from the client device to the server device;
receiving the print job in the server device;
determining the at least one selected image forming device by analyzing the received print job; and
printing the print job using the at least one selected image forming device.
